(19) United States
(12) Patent Application Publication
(10) Pub. No.: US 2010/0173711 A1
(43) Pub. Date: Jul. 8, 2010

(54) HALL EFFECT JOYSTICK

(75) Inventor: Jean-Yves Jaouen, Saint Jean La Poterie (FR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Guillemot Corporation S.A., Chantepie Cedex (FR)

(21) Appl. No.: 12/651,877

(22) Filed: Jan. 4, 2010

(30) Foreign Application Priority Data
Jan. 5, 2009 (FR) 0950025

(51) Int. Cl. A63F 9/24; B23P 17/04

(52) U.S. Cl. 463/38; 29/592.1

(57) ABSTRACT

The invention relates to Hall effect joysticks, and accessories incorporating a Hall effect joystick of a smaller scale. The Hall effect joystick includes a handle which can be moved in relation to a base, in rotation along at least two axes. Said rotation is ensured by way of at least one ball joint including two ball joint elements of roughly the same radius, namely a head and a cup, one being able to pivot around the center of the other. A first of said ball joint elements is fixed in relation to said base and features an opening into which penetrates an extension of said handle, and a second of said ball joint elements is attached to said handle. The extension of said handle includes, in proximity to its lower extremity, at least one sensor and/or at least one magnet of a Hall effect movement detection set.

### BACKGROUND

1. Field of the Invention

The field of the invention is that of interactive hardware and accessories for microcomputers and game consoles.

More precisely, the invention relates to joysticks, and accessories incorporating a joystick. The term “joystick” includes similar devices of a smaller scale, sometimes referred to as “mini-sticks”, which may be incorporated into a gamepad, for example.

2. Background

Joysticks have existed for decades. In broad outline, they include a base, or pedestal, onto which is mounted a handle which can be moved in two directions (x, y), defining a grid parallel to the base, and perpendicular to the zₙₑᵤₜᵣₐₗ axis defined by the handle when it is at rest.

Means for detecting and measuring movement are incorporated into the base. Thus, the movements applied to the handle by a user are detected, and are generally converted into digital signals and transmitted either by wired or wireless means to a data processing device, such as a computer or a game console, so that the data processing device interprets these movements of the handle according to the software used.

A variety of movement detection techniques have been proposed. Initially, four contacts were used, laid out in a cross configuration along the x and y axes.

A contact-free detection technique has also been proposed, using the Hall effect. In this case, a magnet is generally placed at the lower extremity of the handle, and sensors are incorporated (which can also be laid out in a cross configuration, two along the x axis and two along the y axis). The sensors detect variations in the magnetic field, and from these variations the position of the magnet, and therefore of the handle, is calculated.

More particularly, the invention relates to this type of Hall effect joystick.

Known Hall effect joysticks present a number of drawbacks, including, depending on the case:
a high number of pieces to be assembled, and a complicated assembly process, as a result of this number of pieces and/or of the difficulty in holding certain pieces in place before permanent attachment, using screws for example;
instances of relatively significant mechanical looseness as a result of this number of pieces;
difficulty in adjusting the position of the magnet in relation to the sensors;
possible changes to this position over time, or as a result of certain abrupt movements by the user, such as pressing on the handle;
imprecision when returning to the handle's position at rest, or neutral position;
insufficient feel in the area surrounding the handle's position at rest, or neutral position;
relatively large overall size;
. . . .

### SUMMARY

The invention's objective is to overcome these prior art drawbacks, in particular.

More precisely, according to at least one embodiment, an objective of the invention is to produce a Hall effect joystick which is precise to use.

Thus, according to at least one embodiment, an objective of the invention is to produce such a joystick, capable of taking into account small movements of the handle, whatever the handle's position.

Another objective of the invention, according to at least one embodiment, is to produce such a joystick whose overall size is relatively reduced.

Yet another objective, according to at least one of the invention's embodiments, is to produce such a joystick which is easy to assemble, and/or which uses a limited number of pieces to be assembled in relation to known techniques.

These objectives, as well as others to be found hereinafter, are achieved using a joystick including a handle which can be moved in relation to a base, in rotation along at least two axes.

According to the invention, said rotation is ensured by way of at least one ball joint including two ball joint elements of roughly the same radius, namely a head and a cup, one being able to pivot around the center of the other. A first of said ball joint elements is fixed in relation to said base and features an opening into which penetrates an extension of said handle, and a second of said ball joint elements is attached to said handle. Moreover, the extension of said handle includes, in proximity to its lower extremity, at least one sensor and/or at least one magnet of a Hall effect movement detection set (i.e. a set for detecting movements by the way of the Hall effect).

Thus, either the head, or the cup, features an opening into which penetrates an extension of said handle. The “head” and the “cup” (these terms are used by way of analogy to the field of prosthetics, for example) constitute a ball joint. However, either the head is opened, so as to allow for movement of the handle's extension, inside of this head; or the cup is opened, so as to allow for movement of the handle's extension, inside of this cup.

In other words, the joystick includes at least one ball joint including two ball joint elements of roughly the same radius, namely a head and a cup, one being able to pivot around the center of the other, a first of said ball joint elements being fixed in relation to said base and featuring an interior space, and a second of said ball joint elements being attached to said handle, and an extension of said handle penetrating into said interior space, the lower extremity of said extension of said handle moving within said interior space and including at least one sensor and/or at least one magnet of a Hall effect movement detection set.

Thus, the interior space is a free space (it is a clear space), inside of which the lower extremity of the handle can move. It is bounded by a sphere, defined by the contour of the ball joint, and in particular of the head (in other words, the lower extremity of the handle is moving within a clear zone inside the ball joint, i.e. not beneath the ball joint).

The lower extremity of the handle, and a first element (or the first elements) of a movement detection set which is carried by this extremity, can be placed, at rest, approximately at the center of this sphere (thus at the center of the head) so as to allow a great clearance (that is to say freedom and amplitude of movement). The complementary element (or elements) of the movement detection set, fixed in relation to the base, can also be lodged inside the ball joint.

This structure allows for a simple and compact assembly, as well as efficient measurement of magnetic fields.

According to a first specific embodiment, said base includes an essentially hemispherical fixed cup, working in conjunction with a partially spherical head, of roughly the same radius, said head being attached to said handle and said head being able to pivot around the center of said cup. Said cup features an opening in its lower section, into which penetrates an extension of said handle, including in proximity to its lower extremity at least one sensor and/or at least one magnet of a Hall effect movement detection set.

According to a second specific embodiment, said base includes a partially spherical fixed head, working in conjunction with an essentially hemispherical cup, of roughly the same radius, said cup being attached to said handle and said cup being able to pivot around the center of said spherical head. Said spherical head features an opening in its upper section, into which penetrates an extension of said handle, including in proximity to its lower extremity at least one sensor and/or at least one magnet of a Hall effect movement detection set.

According to a specific embodiment, said interior space features a flared upper portion, the borders of which form a stop for said extension, and an essentially cylindrical portion.

The extremity of the extension therefore moves within this cylindrical portion.

To ensure effective control of this movement, specific means may be used ensuring a connection between the borders of the opening and the extension. In particular, a pivoting piece may be pivotally mounted in said opening on two bearings, working in conjunction with said extension.

In this case, according to a first specific embodiment, said pivoting piece may feature an oblong opening extending along an axis defined by said bearings, and into which penetrates said extension, so as to allow for the pivoting of said extension in relation to said pivoting piece in the direction of said opening.

This pivoting thus allows for two degrees of freedom of rotation. According to one variation, we may use a Cardan joint, whereby one of the yokes of the joint is attached to the fixed spherical head.

According to one particular aspect, primary return mechanisms may be used, in order to maintain said cup and said head in contact with one another and/or to return said handle to a neutral position.

In particular, said primary return mechanisms may act by way of compression between said base and a mobile support which can slide along a direction which is parallel to the direction of the neutral axis of said handle, and acting on at least one border of said cup.

According to a first embodiment, said primary return mechanisms act between a lower section of said base and said mobile support.

According to a second embodiment, said primary return mechanisms act between an upper section of said base and said mobile support.

This approach allows for the cup to be properly maintained in relation to the head, and to effectively return the handle to its neutral position.

According to this second embodiment in particular, the border of said cup may feature an edge which comes into contact with a shoulder formed on said mobile support.

In order to avoid any possible blockages, this edge may be rounded or inclined in relation to the horizontal plane (or, more precisely, to the grid (x,y)). Similarly, in order to avoid any possible blockages, the portion of the shoulder that is in contact with this edge may be inclined in relation to the horizontal plane (or, more precisely, to the grid (x,y)).

According to a particular embodiment, said primary return mechanisms may include a coil spring guided by said mobile support on a substantial portion of the height of the base.

Such a spring should preferably be prestressed, and coaxial to the axis defined by the handle in its neutral position.

According to a particular embodiment, balancing means may be included allowing for at least partially balancing of the forces exerted by said primary return mechanisms.

These balancing means, by opposing the force applied by the primary return mechanisms, when the handle is in its neutral position and in the surrounding area, allow the user to enjoy better feel from the joystick in this central zone, where great precision is generally required.

Said balancing means may also include secondary return mechanisms in particular, mounted between said mobile support and said base, and for example, if said mobile support is mounted on columns parallel to the neutral axis (zₙₑᵤₜᵣₐₗ) of said handle, a coil spring mounted on each of said columns.

According to another particular aspect of the invention, said Hall effect sensor may be a triaxial sensor.

In this way, it is possible to obtain good precision, in the space, regarding the position of the handle's extremity.

According to an embodiment of the invention, said Hall effect sensor is mounted on a printed circuit lodged at the bottom of said interior space.

In this case, the magnet is mounted at the extremity of the handle's extension. It is also possible to reverse the positions of the magnet and the sensor.

According to a particular aspect of the invention, the joystick includes a single magnet and a single sensor, aligned with the axis of said handle when the handle is in a neutral position.

In this way, it is possible to obtain very good precision of measurement. This measurement is direct, without mechanical intermediaries which may result in “dead” zones of calculation, caused by looseness for example.

According to another aspect of the invention, said handle may be hollow.

The invention also relates to a manufacturing process for a joystick such as described above. Such a process includes the following steps, in particular:
obtaining a lower section of said base, including said head or said cup;
putting in place on said head of said cup, or of said cup on said head, said extension penetrating into said interior space;
closing of said base, by placing an upper section of said base and attaching this upper section to said lower section.

Moreover, the process may contain at least some of the following steps:
making said extension interdependent with said head, using a pivoting piece;
putting in place a mobile support coming into contact with said cup and guided in sliding in relation to said base;
putting in place return mechanisms between said base and said mobile support, whose action is to return the latter to a position in which said handle is in a neutral position.

The invention also relates to gamepads, and similar accessories more generally, including at least one joystick as described above.

### BRIEF DESCRIPTION OF THE DRAWINGS

Other features and advantages of the invention will be revealed more clearly upon reading the following description of a preferential embodiment of the invention, provided by way of illustration only and non-restrictive in nature, and the appended diagrams, among which:

FIG. 1 illustrates an example of a joystick module according to the invention, according to a first embodiment;

FIGS. 2 and 3 are two cross-sectional views, along the x and y axes respectively, of the module shown in FIG. 1;

FIG. 4 is a perspective view of the pivoting piece visible in FIGS. 2 and 3;

FIG. 5 diagrammatically presents the main steps of mounting a module as illustrated in FIGS. 1 to 4;

FIG. 6 illustrates, in cross-section, a second embodiment of the invention;

FIG. 7 illustrates a third embodiment of the invention, using secondary springs in order to enhance the joystick's functioning, particularly in the area surrounding the neutral position.

### DETAILED DESCRIPTION

The invention thus relates to a new Hall effect joystick, simple to manufacture and offering great precision.

In the following passages we shall describe an example of the invention's mechanical system, in the form of a module which may then be added to, by way of external design elements, for example, in the case of a “joystick”, using a base and an ergonomic covering for the handle. This base and this handle may include different additional elements, such as interface means (buttons, actuators, potentiometers . . . ), signal processing and transmission methods, information reproduction means (indicator lights, vibration devices, force feedback . . . ), ballast elements . . . .

Such a module according to the invention, and if necessary several specimens of such a module, may also be put in place on a gamepad.

The patent claims relate to the modules as described in the following passages as such, and also to the joysticks, gamepads, or other similar accessories, incorporating one or more modules.

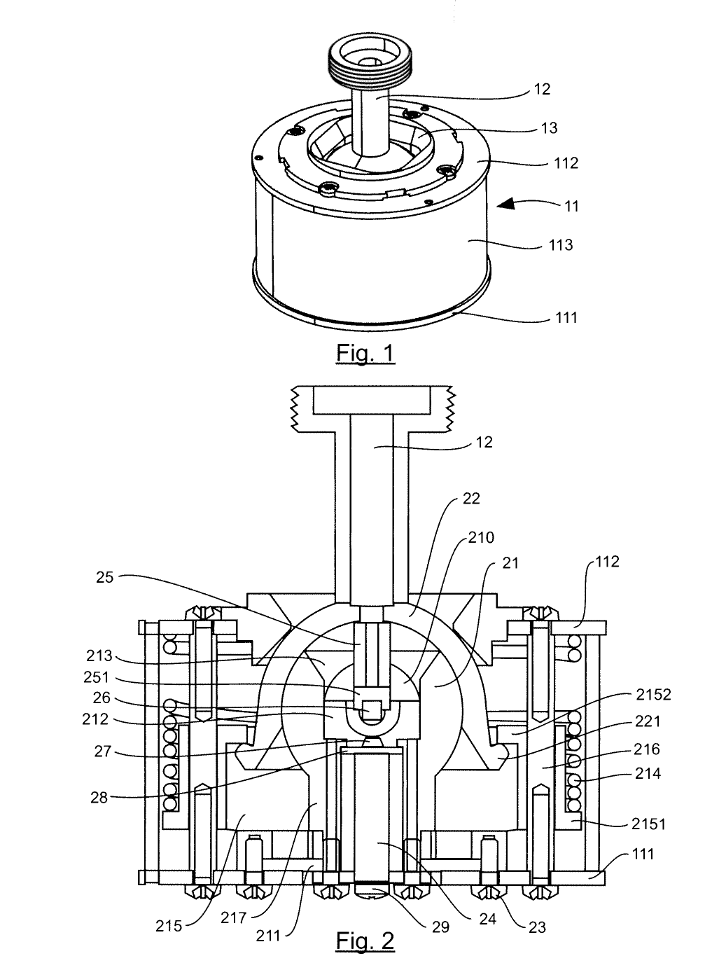

FIG. 1 diagrammatically presents such a module. It includes a base, or base element, 11, formed of a lower capsule 111, an upper capsule 112 and side wall 113. The capsules are made of stainless steel, for example.

A handle 12 can move in relation to the base 11, along the x, y grid. To enable this, an opening 13 is made in the upper capsule 112.

We shall refer to the axis defined by the handle 12 hereinafter as the z axis. When in its resting position, or neutral position, this neutral axis is referred to as zₙ, or zₙₑᵤₜᵣₐₗ. This axis zₙ, is perpendicular to the x, y grid.

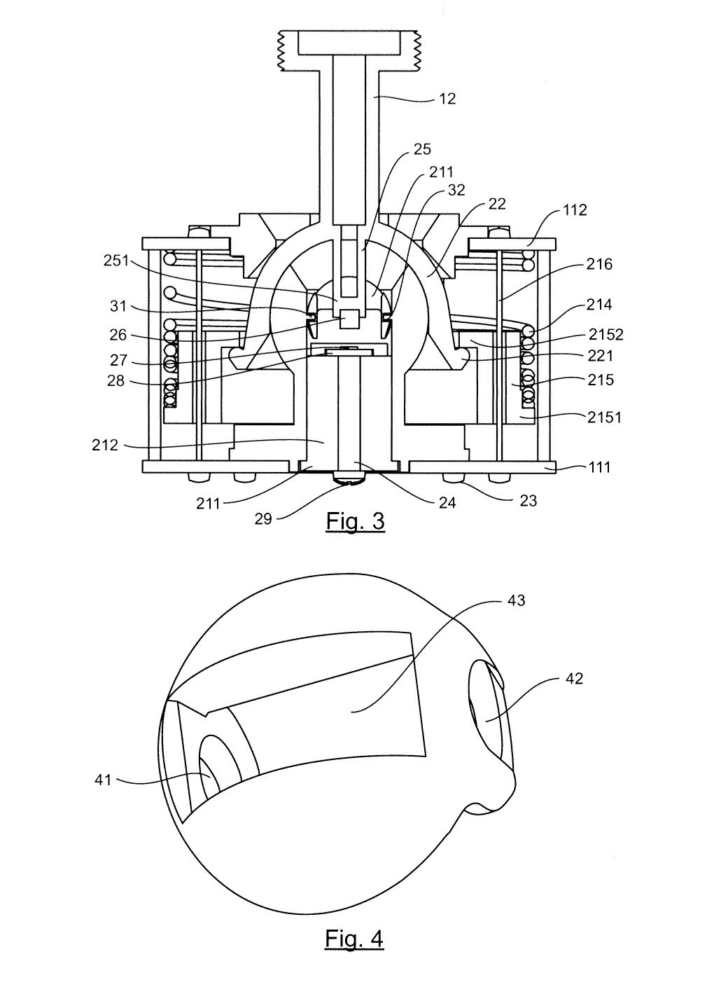

As it appears in the cross-sectional views shown in FIGS. 2 and 3, which correspond to cross sections along two perpendicular x and y axes, respectively, the module includes a fixed head 21, over which is supported a cup 22. This head 21 and this cup 22 form a ball joint, the cup being able to pivot around the center of the head.

The head 21 is formed in one piece (made of polyoxymethylene (POM) with Teflon (registered trademark) added, for example) featuring an attachment zone 211 to the lower capsule 111, and a linking zone, cylindrical for example, 217 extending between the head properly speaking (that is to say, the partially spherical surface over which the cup is supported) and the attachment zone 211.

Attachment of the attachment zone 211 to the lower capsule 111 is carried out using one or more screws 23, for example. Attachment may also be carried out by way of bonding for example, or else be directly molded or overmolded onto the lower capsule 111.

The cup, or dome, 22, is mounted on the handle 12, so as to control, in the form of rotations, the movements applied by the user to this handle.

An extension 25 is formed in the extension to the handle 12, in order to extend along the z axis, into the interior of the cup 22.

The piece formed by the handle 12, the cup 22 and the extension 25 may be formed, for example by molding or overmolding, into a single piece. The handle and its extension may be hollow, which allows for electrical wires to be passed through, in particular.

This piece may be made of polyamide (PA 45% CFV for example), in particular.

The head 21 therefore has a truncated spherical shape in its upper section, featuring a flared opening 213, inside of which the extension 25 can penetrate. The dimensions and borders of this opening 213 may be favorably adapted to serve as stops for the extension 25, in the extreme inclination positions of the handle 12.

The opening 213 in the head 21 extends into an essentially cylindrical zone 212, inside of which moves the extremity 251 of the extension 25, which is equipped with a magnet 26. The opening 213 and the cylindrical zone 212 define an interior space of the ball joint (and of the head, as it happens), inside of which penetrates the extension 25, so that its extremity 251 in particular, and therefore the magnet 26, moves within this interior space. We note that the movement of this magnet 26 takes place inside of the head 21, and in particular that the interior space 212 is bounded by a sphere which is defined by the surface of the head 21, if we fictively extend the partially spherical surface over which the cup is supported.

At the bottom of the zone 212, is mounted a Hall effect sensor 27, which is for example a sensor such as the triaxial sensor which is offered by the Melexis (registered trademark) company.

Thus, according to this embodiment, the Hall effect movement detection set (magnet 26 and sensor 27) is lodged inside the ball joint, that is to say inside the sphere defined by the surface of the head 21.

This Hall effect sensor 27 is mounted on a printed circuit 28, or PCB, attached to the head 21. The presence of a triaxial, or 3D, sensor allows for the device to provide very good precision.

According to a favorable embodiment, the space extending below this printed circuit 28, from the lower capsule 111, is a free space 24, available in particular for settings and calibration of the sensor 27 and/or for passing through wires. A piece 29 (a screw or a guard plate, for example) may then be inserted into this space 24, to block it off.

In order to prevent the handle 12 from turning on itself, a pivoting element 210 may be included, which allows for the handle 12 to pivot in the desired directions, but not turn on itself, along the z axis. An example of this pivoting piece 210, which may also help to prevent variations in the height of the magnet 26, is more precisely illustrated in FIG. 4.

First, the pivoting piece 210 includes two circular openings 41 and 42, adapted to work in conjunction with two bearings 31, 32, formed in the head 21. These bearings allow for pivoting movements in a direction x (if we consider that the bearings extend along the y axis).

Along this y axis, the pivoting piece 210 also includes an oblong opening 43, inside of which the extension 25 can move, along the y axis.

Thus, thanks to this pivoting piece 210, it is possible to control the pivoting of the handle 12 along the two x and y axes, and therefore on the grid (x, y), without the handle 12 turning along its z axis.

This piece may be made of polyamide (PA 45% CFV for example), in particular.

Of course, this pivoting piece may be designed in an appreciably different manner, still allowing for two degrees of freedom of rotation, for example in the form of a Cardan joint, whereby one of the yokes of the joint is attached to the fixed spherical head, and the other to the handle's extension.

The fact that the magnet 26 is placed, for example by flush fitting, at the extremity 251 of the extension, allows for direct transfer of the handle's movement, without any mechanical intermediary.

We shall not detail herein the calculation of the positioning of this magnet, carried out by the sensor 27, which is known. The sensor 27, which may be a commercial sensor, delivers a digital signal representing this position.

It is understood that the proposed structure, in which the measurement between the magnet 26 and the sensor 27 is direct, without any mechanical intermediary, allows for great precision, and in particular for taking small movements into account, no matter what the position of the handle 12. This also allows for avoiding any “dead” zones of calculation which otherwise might appear, caused by looseness for example.

Return mechanisms, here in the form of a coil spring 214 prestressed in compression, allow the handle 12 to automatically return to its neutral position (along the zₙ axis), when the handle is moved even the slightest bit.

The spring 214 acts on a spring support, referred to hereinafter as mobile support 215 (made of polyoxymethylene (POM) with Teflon added (registered trademark), for example), guided in movement (translatory motion) within the module, along the zₙ axis, for example using four columns 216, which may be made of stainless steel in particular. The spring is placed alongside these four columns, and is prestressed in compression by the upper capsule 112. It acts upon a lower edge 2151 of the mobile support 215, tending to push the mobile support downwards.

The mobile support 215 also features an upper edge, or shoulder, 2152, which comes into contact with an edge 221 of the cup, extending towards the exterior (as opposed to the interior of the cup). The edge 221 of the cup and/or the shoulder 2152 of the mobile support may feature shapes and surfaces well-adapted to working in conjunction with one another, and tending to return the handle to its neutral position.

It is understood that, when the handle 12 is inclined in one direction, the cup 22 moves in rotation around the head 21, resulting in the upward displacement of its edge 221, towards the side which is opposite the direction applied to the handle. The edge 221 acts against the shoulder 2152, which tends to raise the mobile support 215, which slides along the length of the columns 216.

The spring 214 acts against this movement. Thus, when the user releases the handle, the spring 214 returns the mobile support 215 to its resting position. The support acts on the cup 22, also bringing it to a resting position, corresponding to the return of the handle 12 to the neutral position.

In order to limit wear between the shoulder 2152 and the edge 221 of the cup, we may for example use the overmolding of a sheet onto the shoulder 2152 (this sheet being placed between the shoulder 2152 and the edge 221).

In some cases, it may be desirable to provide better feel for the user of such a joystick, in the area surrounding the handle's neutral position, which is to say when the handle is in positions close to this neutral position. This neutral position, or central position, generally requires great precision.

To achieve this, partial balancing means may be added, as shown in FIG. 7. As specified by the following, the expression “partial balancing means” refers to means which partially compensate for the force of the main spring 214, allowing for the joystick to be more easily movable in the area surrounding its neutral position, while the resulting force nevertheless effectively returns the handle to its neutral position when released by the user.

The joystick shown in this FIG. 7 is similar to that in FIG. 2, the common elements of which, already described above, shall not be summarized again.

According to this embodiment, partial balancing means are included with respect to the forces exerted by the main spring 214 (or primary return mechanisms), in the form of secondary return mechanisms placed between the base 11, and more precisely the lower capsule 111, and the mobile support 215.

These secondary return mechanisms include four coil springs (three of which, numbered 71₁, 71₂, 71₃ are visible in FIG. 7) mounted on the four columns 216. According to other implementations, leaf springs may be used, or elastic means more generally, appropriately placed between the lower capsule 111 and the mobile support 215.

When the handle 12 is inclined, for example by way of rotation around the ball joint head according to the arrow 72, the mobile support 215 moves away from the lower capsule 111, according to the arrow 73. This movement results in compression of the main spring 214. The secondary springs 71₁, 71₂, 71₃ are thereby slackened and have little effect.

In contrast, in the central zone (that is to say, in the area surrounding the position at rest), the secondary springs 71₁, 71₂, 71₃ are compressed to the maximum, tending to fully or partially compensate for the forces applied on the mobile support 215 by the main spring 214. The resultant of the forces applied by this main spring 214 and the secondary springs 71₁, 71₂, 71₃ acting in opposition is thereby reduced, in relation to the force of the main spring alone (according to the approach in FIG. 2). This results in the joystick being much more easily movable in the central zone, thereby providing better feel for the user.

The springs (main spring and secondary springs) are selected so as to provide the desired compromise between comfort (which assumes a relatively weak resultant of forces), and precise and effective returning of the joystick to its neutral position (which assumes a sufficient resultant of forces). A good feel for users is the result of a compromise. Users do not necessarily appreciate having a joystick which is too easily movable in the area surrounding its central position, and therefore equilibrium or quasi-equilibrium of forces is not necessarily a good compromise. This good compromise shall be achieved for example by way of successive trials, taking into account the opinions expressed by a majority of users and/or according to the reactions of testers who are avid flight simulation enthusiasts.

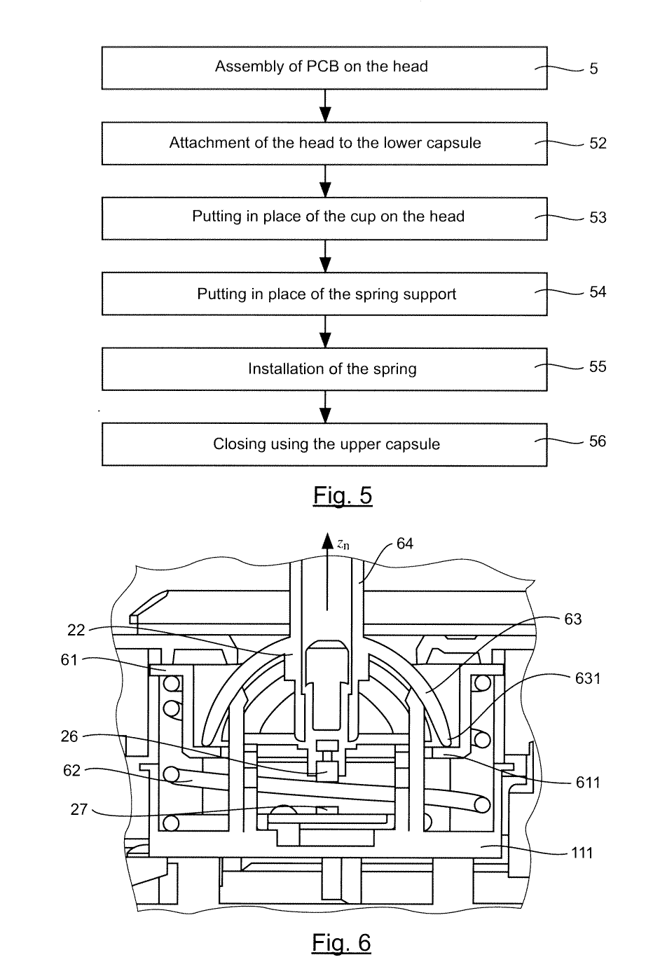

The assembly of such a joystick is relatively simple, particularly with respect to known techniques. FIG. 5 diagrammatically illustrates an example of the assembly process, in the form of a simplified synoptic, presenting the main steps.

Thus, first of all we assemble (51) the PCB 28 (onto which the sensor 27 and required electrical wires have already been soldered) on the head 21, in a housing designed to this effect. The attachment may be carried out by way of clipping and/or bonding, for example. The electrical wires are placed in the open space underneath the PCB.

Next, the head 21 is attached (52) to the lower capsule 111, using screws for example. We will already have been able to pre-equip the lower capsule, in particular with the side wall 113 and columns 216.

The handle 12, equipped with its cup 22 and its extension, onto which the magnet 26 has been attached, by clipping and/or bonding for example, is then put in place (53), so that the cup 22 crowns the head 21. The extremity of the extension is placed into the oblong opening of the pivoting piece 210, which has already been mounted on the head's bearings.

We then put in place (54) the mobile support 215, on the columns 216, which have already been mounted, using screws for example, onto the lower capsule 111. This mobile support may slide freely along the length of the columns. The shoulder 2152 of this mobile support comes into contact with the edge 221 of the cup. In the case of a joystick as shown in FIG. 7, the secondary springs 71₁, 71₂, 71₃ have obviously been mounted on the columns 216, before putting in place the mobile support 215.

We then install (55) the spring 214 onto the mobile support 215, and close (56) the base, using the upper capsule 112, which is screwed onto the columns for example. This action simultaneously results in compression of the spring 214 (in the case of a joystick as shown in FIG. 7, this action may also results in compression of the secondary springs 71₁, 71₂, 71₃).

We may then proceed with adjustments to and calibrations of the sensor, and add on to the ensemble thus obtained the covering and additional functions required according to the applications.

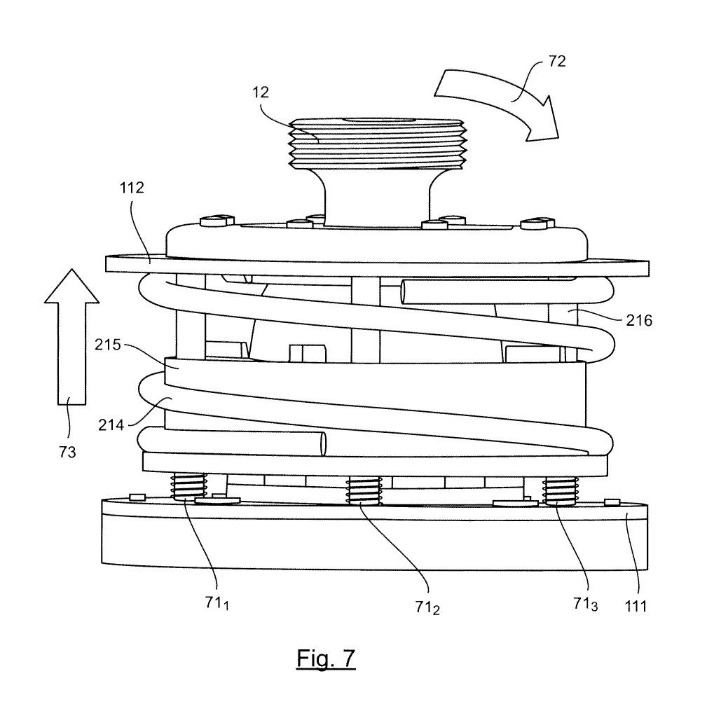

FIG. 6 illustrates another embodiment of the invention. The elements similar to the first embodiment are not described in detail. The major difference in relation to the first embodiment is the mounting of the mobile support 61 and of the spring 62. In this approach, the spring 62 is compressed between the lower capsule 111 and the mobile support 61, which is therefore pushed upward. In this case, this mobile support defines a support zone 611 which supports the border 631 of the cup 63.

It is understood that, in the same way as before, the spring acts on the mobile support, and therefore on the cup, so as to return the cup to the neutral position, into which the handle 64 extends along the zₙ axis.

Depending on other variations of the invention, it is possible to invert the cup and the head. In this case, the cup defines a fixed receptacle, integral with or attached to the base, in which the head is supported, said head being attached to the handle. An extension, featuring a magnet, respectively a sensor, crosses the head, working in conjunction with a sensor, respectively a magnet, lodged at the bottom of the cup.

1. Joystick including a handle which can be moved in relation to a base, in rotation along at least two axes,
wherein said joystick includes at least one ball joint including two ball joint elements of roughly the same radius, namely one head and one cup, one of the elements being able to pivot around the center of the other element,
a first of said ball joint elements being fixed in relation to said base and featuring an interior space, and a second of said ball joint elements being attached to said handle,
and wherein an extension of said handle penetrates into said interior space, the lower extremity of said extension of said handle moving in said interior space and featuring at least one sensor and/or at least one magnet of a Hall effect movement detection set.

2. Joystick according to claim 1, wherein said head is a partially spherical and fixed head, supported by said base, and wherein said cup is essentially hemispherical and attached to said handle, said cup being able to pivot around the center of said spherical head,
and wherein said spherical head features an opening in its upper section, through which said extension of said handle penetrates into said interior space.

3. Joystick according to claim 1, wherein said interior space features a flared upper portion, the borders of which form a stop for said extension, and an essentially cylindrical portion.

4. Joystick according to claim 1, wherein is included a pivotally mounted pivoting piece which can pivot in said interior space on two bearings, and working in conjunction with said extension.

5. Joystick according to claim 4, wherein said pivoting piece features an oblong opening extending along an axis defined by said bearings, and into which penetrates said extension, so as to allow for the pivoting of said extension in relation to said pivoting piece in the direction of said opening.

6. Joystick according to claim 1, wherein are included primary return mechanisms whose function is to maintain said cup and said head in contact with one another and/or to return said handle to a neutral position.

7. Joystick according to claim 6, wherein said primary return mechanisms act in compression between said base and a mobile support, which can slide along a direction which is parallel to the direction of the neutral axis of said handle, and acting on at least one border of said cup.

8. Joystick according to claim 7, wherein said primary return mechanisms act between a lower section of said base and said mobile support.

9. Joystick according to claim 7, wherein said primary return mechanisms act between an upper section of the said base and said mobile support.

10. Joystick according to claim 9, wherein the border of said cup features an edge which comes into contact with a shoulder formed on said mobile support.

11. Joystick according to claim 7, wherein said primary return mechanisms include a coil spring guided by said mobile support on a substantial portion of the height of the base.

12. Joystick according to claim 6, wherein are included balancing means with respect to the forces exerted by said primary return mechanisms.

13. Joystick according to claim 12, wherein said balancing means include secondary return mechanisms, mounted between said mobile support and said base.

14. Joystick according to claim 13, wherein said mobile support is mounted on columns parallel to the neutral axis of said handle, and wherein said secondary return mechanisms include a coil spring on each of said columns.

15. Joystick according to claim 1, wherein said Hall effect sensor is a triaxial sensor.

16. Joystick according to claim 1, wherein said Hall effect sensor is mounted on a printed circuit lodged at the bottom of said interior space.

17. Manufacturing process for a joystick according to claim 1, wherein the following steps are included:
obtaining a lower section of said base, including said head or said cup;
putting in place on said head of said cup, or of said cup on said head, said extension penetrating into said interior space;
closing of said base, by placing an upper section of said base and attaching this upper section to said lower section.

18. Gamepad, wherein is included at least one joystick according to claim 1.
